(19) United States
(12) Patent Application Publication
(10) Pub. No.: US 2005/0273721 A1
(43) Pub. Date: Dec. 8, 2005

(54) Data transformation system

(76) Inventor: David Brook Yantis, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/135,965

(22) Filed: May 24, 2005

Related U.S. Application Data
(60) Provisional application No. 60/577,555, filed on Jun. 7, 2004.

(51) Int. Cl. G06F 17/00; G06F 9/00

(52) U.S. Cl. 715/762; 707/1; 715/513; 715/526

(57) ABSTRACT

A data transformation system includes a display generator for displaying an image. The image includes a first window showing a first data structure having at least one data element and a second window showing a second data structure having at least one data element. The image also includes a display element enabling a user to specify an operation for transforming the at least one data element in the first data structure to a corresponding at least one data element in the second data structure. A processor compares the first and second data structures and conditions the display generator to visually indicate structural differences in the data structure shown in the first window and/or the data structure shown in the second window.

This is a non-provisional application of provisional application Ser. No. 60/577,555, filed Jun. 7, 2004 by David B. Yantis.

### FIELD OF THE INVENTION

The present application relates to a system for transforming the content and structure of files containing data, and more specifically, to a system for detecting the respective data structures of data in a source file and a destination file and transforming data from the source file to the destination file.

### BACKGROUND OF THE INVENTION

Databases are widely used to store and retrieve data for use in business, scientific and other enterprises. The data elements in databases have a predefined structure, termed a ‘schema’. For example, in a relational database, data is stored in data table form, in which a data table contains one or more data rows or data records, and a data row contains one or more data fields. Corresponding data fields in the data records form data columns. The data tables generally contain related information. For example, one data table may contain data about patients, another data table may contain data about doctors, another data table may relate which doctors have treated which patients, another may contain data about insurance companies, and so forth.

Each data field contains information which represents some piece of data. For example, one data field may contain information which represents a person's name, another data field may contain information which represents a person's age, and so forth. Data fields also have attributes which describe that data field. For example, the name and age data fields may have an identifier attribute, such as “Name” and “Age”, respectively, Data fields may also contain different types of data indicated by a data type attribute. The name and age data fields contain text and integer data, respectively, indicated by “text” and “integer” data type attributes. Other data types exist such as: date, time, real number, logical (true/false), URL, currency value, currency type, enumerated (such as a list of states or zip codes), social security numbers, phone numbers, and so forth. The type of data controls the format of the data. That is, date type data is stored and displayed differently from integer data, and so forth. Data fields may have other attributes as well, such as whether a data field is required to contain information and so forth.

Other types of databases use other structures to identify data. For example, in a hierarchical database, database elements may include data and attributes, as described above, but may also be associated with child data elements which also include data and attributes. In turn, those child data elements may be associated with grandchild data elements including data and attributes, and so forth to any depth. One example of such a hierarchical database structure is an XML data document. XML data documents identify the names and attributes of the data elements, and their children and grandchildren data elements, etc., within the document or using an associated XML schema document.

Regardless of the type of database, a schema contains data describing the data elements (e.g. data field name, attributes, associated children data elements, etc.) in that database. The data describing the database, such as data field names and attributes, is termed ‘metadata’. As enterprise database systems are typically developed, data desired to be stored in a database is identified, and metadata describing that data is generated. A database is designed and implemented based on the metadata. The database is populated with data by the user and data is added, modified and/or retrieved as required.

Typically, database developers design a database to include the generally required or desired data for a particular enterprise. For example, for a healthcare enterprise, the database is developed to contain data about patients, doctors, hospitals, insurance companies and their insurance products, and so forth. This database is distributed to customers who populate it with data related to their own practice.

A database developer generally provides the ability for customers to add additional data to the database which is important to their own business. In such systems, the customer determines the desired additional data, generates metadata describing the data fields necessary to store this data, augments the database with data fields according to the metadata, and populates these fields with data. Thus, while a core database product, containing generally desired data, is distributed to customers, a customer has the ability to augment the data stored in that database with data desired by that customer.

As the database developer continues development of the database product, upgrades are issued to the customers. These upgrades sometimes include an augmented database, i.e. a database including additional data elements. However, because different customers may have augmented their installed database in different ways, a common update procedure may not be used for different customers. There are several potential problems. First, a customer may have augmented the database by adding data elements having the same name and attributes as new data elements in the upgrade from the developer. Second, the data elements added by the customer may or may not refer to the same data as those added by the developer. Third, even if the data elements refer to the same data, the intended content of the field may be different. For example, a “Quantity” field added by both the developer and the customer may both refer to the number of items in inventory, but one may use the units ‘dozens’ while the other may use the units ‘gross’. Thus, upgrading the customer database requires transforming the schema of the customer database in such a fashion that the schema of the augmented database from the developer may be implemented on the customer database without losing data already in the customer database.

Prior art database systems require a database technician to transform the database at each customer location manually. The technician reviews the schema of the updated database provided by the database developer and the schema of the customer database as currently augmented by the customer. From the review, the technician determines how to transform the schema of the current customer database to the schema of the upgraded database from the developer, and also how to transform data stored in the current database so that it may be stored properly in the upgraded customer database. This is a process which can be very labor intensive and is subject to errors.

Data transformation systems have been developed to assist a technician in transforming the schema of, and data stored in, a first database, e.g. a current customer augmented database, to a second database, e.g. an upgraded database from a vendor. Some such systems are designed including knowledge of the schema of the destination database, and require the user to enter information defining the schema of the source database and rules for transforming the data in the data fields in the source database to data suitable for storage in the data fields in the destination database. Once developed, those rules may be applied to the data in the source database to generate data which is used to populate the destination database.

Another such system analyzes the schemas in the source database and the destination database and presents this information graphically to the user. The user then may use a graphical user interface (GUI) to associate one or more fields in the source database with one or more fields in the destination database and to specify specific operations to be performed on data in the source database to generate data suitable for storage in the destination database. Once this information has been generated by the user, the data in the source database may be transformed into data in the destination database in response to the transformation information.

Other such systems have been developed to automate the process of transforming data from a first, source, database having a first data structure to a second, destination, database having a second structure. Such systems automatically analyze the source database and destination database and attempt to associate one or more data elements in the source database with the correct one or more data elements in the destination database. Several techniques exist for performing such an analysis. In one technique, the source and destination databases are compared and the likelihood of a match between respective data elements is determined. When the analysis is complete, the data element in the destination database which has the highest likelihood of matching a data element in the source database is assumed to be associated with that destination database data element.

One technique for performing the comparison is to compare the schemas of the source and destination databases. For example, the system may compare the data element names in the source and destination databases. Data element names which are the same or similar are assigned a higher likelihood of matching than data element names which are not similar. Other attributes may also be considered during the comparison process. For example, data elements with the same data type (e.g. text, integer, logical, etc.) are assigned a higher likelihood of matching than data elements with different data types. The system may also compare the structural aspect of the schemas. That is, for hierarchical databases, the tree structure of parent, child, grandchild, etc. data elements in the source and destination databases may be compared. Data elements in tree structures which are similar in arrangement are assigned a higher likelihood of matching than data elements in less similar tree structures.

Another technique for performing the comparison is to compare data in the source and destination databases. For example, the content of data elements already stored in the source and destination databases may be compared to determine their similarity. Data elements with data content which is similar in the source and destination databases is assigned a higher likelihood of matching than data which is less similar. For example, data elements which both contain data formatted as phone numbers are more likely to match than data elements where one contains data formatted as text and the other contains an integer. Any combination of the above mentioned techniques and/or any other technique for generating a likelihood of a match between source data elements and destination data elements may be used.

However, there are many different ways in which database designers may structure the same data in a database. For example, some database designers may specify a “Name” data element with child data elements for “First”, “MI” (for middle initial), “Last”, “Honorific”, “Suffix”, etc. Other database designers may specify those same data elements as siblings at the same level with no parent data element. Still others may use the data element identifiers “Given”, “Middle”, “Family” or “Surname”. Still others may use a single data element “Name” to contain the full name including the components described above. Similarly, some may separate a phone number into an “Area code” data element and a “Phone number” data field, while others may specify a single “Phone number” data element containing both the area code and phone number. The same information is included in the cases described above, but the schemas and data content of such databases may be very dissimilar. Such differences in the structure of the database and the content of the data elements for the same information means that automatic transformation systems still require that a database technician review the results of the automatic transformation and to revise the transformation process.

A data transformation system is desirable which will assist a user in transforming a source database to a destination database, while allowing the user to easily specify and modify required transformation details.

### BRIEF SUMMARY OF THE INVENTION

In accordance with principles of the present invention a data transformation system includes a display generator for displaying an image. The image includes a first window showing a first data structure having at least one data element and a second window showing a second data structure having at least one data element. The image also includes a display element enabling a user to specify an operation for transforming the at least one data element in the first data structure to a corresponding at least one data element in the second data structure. A processor compares the first and second data structures and conditions the display generator to visually indicate structural differences in the data structure shown in the first window and/or the data structure shown in the second window.

Such a data transformation system obviates the manual process of identifying differences between two metadata structures. The data transformation system highlights the differences between the metadata schemas and guides the user through the process of defining the transformation from one metadata schema to another.

### BRIEF DESCRIPTION OF THE DRAWING

In the drawing:

FIG. 1 is a block diagram of a data transformation system according to principles of the present invention;

FIG. 2 and FIG. 3 are hierarchical diagrams of source and destination database schemas, respectively, useful in understanding the operation of the embodiment illustrated in FIG. 1;

FIG. 4 and FIG. 5 are respective images of graphical user interfaces (GUI) generated by the embodiment illustrated in FIG. 1; and

FIG. 6 is a flowchart illustrating the operation of the executable application in the embodiment illustrated in FIG. 1.

### DETAILED DESCRIPTION OF THE INVENTION

As used herein, a processor operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprise any combination of, hardware, firmware, and/or software.

An executable application as used herein comprises code or machine readable instructions for conditioning the processor to implement predetermined functions, such as those of an operating system, database management system, or other information processing system, for example, in response user command or input. A user interface comprises one or more display images, generated by the display processor under the control of the processor, enabling user interaction with a processor or other device.

A data transformation system provides a method for defining how to transform data from a first database having a first metadata schema to a second database having a second metadata schema. The data transformation system guides a user through the process of identifying the differences between an existing metadata structure and a new metadata structure. As the differences are presented to the user, the user defines how to transform the data from the old metadata schema into the new metadata schema. The end result of this process is a data transformation specification containing the transformations created by the data transformation system. A data transformation engine (not germane to the present application and not described in detail below) performs the data transformations using the data transformation specification output from the data transformation system.

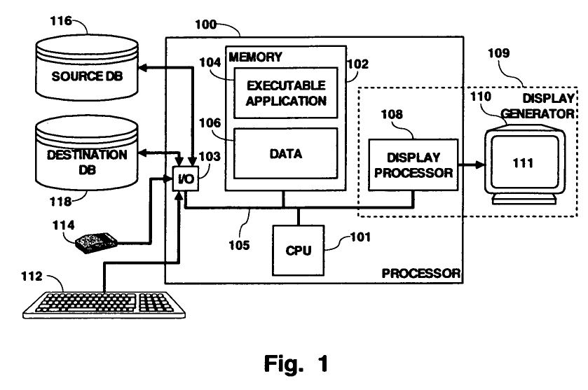

In FIG. 1, a processor 100 includes a central processing unit (CPU) 101, a memory 102, an input/output (I/O) adapter 103, and a display processor 108 interconnected by a processor data bus 105. The memory 102 includes read-write memory (RAM) and read-only memory (ROM) (neither shown), and holds data representing an executable application 104, data 106 processed or generated by the executable application, and/or any other data (not shown) required by the CPU 101. The I/O adapter 103 is coupled to a storage device 116 containing a source database, and a storage device 118 containing a destination database. While illustrated in FIG. 1 as separate storage devices 116 and 118, the source and destination databases may be stored in a single storage device, or may be stored on multiple storage devices forming a distributed database possibly coupled to the processor 100 via a client processor (not shown) through a network such as a local area network (LAN) and/or a wide area network (WAN) (not shown) such as the internet. The I/O adapter 103 is also coupled to input devices such as a keyboard 112 and a pointing device, e.g. mouse 114. Other input and output devices may also be coupled to the I/O adapter 103.

The display processor 108 is coupled to a display device 110 such as a CRT or LCD monitor which is capable of displaying an image in a display area 111 under the control of the display processor 108. The combination of the display processor 108 and the display device 110 form a display generator 109. Similarly to the storage devices 116 and 118 and the keyboard 112 and mouse 114, the display processor 108 may be coupled directly to the processor 100, or may be coupled to the processor 100 via a client processor (not shown) through a LAN and/or WAN.

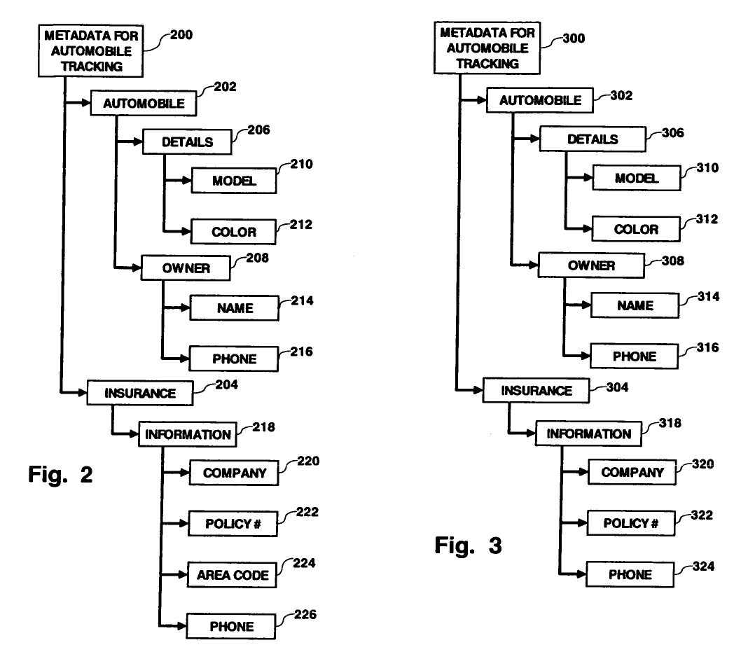

The operation of the system illustrated in FIG. 1 is described in more detail below with reference to example source and destination databases. In the example, hierarchical databases are illustrated. One skilled in the art will understand that any form of database may equally well be transformed by the illustrated embodiment. FIG. 2 illustrates metadata describing a source database and FIG. 3 illustrates metadata describing a destination database. In FIG. 2 and FIG. 3 metadata representing a database for tracking automobiles and insurers is illustrated.

In FIG. 2, the schema of the source database includes a root node 200 which has a first child node 202 representing an automobile, and a second child node 204 representing the automobile insurance. The automobile node 202 has a first child node 206 representing details about the automobile and a second child node 208 representing the owner of the automobile. The automobile node 202 has a first child node 210 representing the model of the automobile and a second child node 212 representing the color of the automobile. The owner node 208 has a first child node 214 representing the name of the owner and a second child node 216 representing the phone number of the owner. The insurance node 204 has a single child node 218 representing information about the insurance policy. The information node 218 has a first child node 220 representing the insurance company, a second child node 222 representing the insurance policy number, a third child node 224 representing the area code of the insurance company, and a fourth child node 226 representing the phone number of the insurance company.

The schema of the destination database illustrated in FIG. 3 contains, with one exception, the same structure as that of the source database (FIG. 2). In the source database (FIG. 2) data representing the phone number of the insurance company is partitioned into an area code node 224 and a local phone number node 226, while in the destination database (FIG. 3) data representing the phone number of the insurance company, including both area code and local number, is stored in a single phone number node 324. Thus, in order to transform data from the source database (FIG. 2) to the destination database (FIG. 3), data stored in the data nodes 224 (area code) and 226 (phone) must be merged and stored in the single data node 324 (phone).

Referring again to FIG. 1, in the processor 100, the data transformation executable application 104, as executed by the CPU 101, accesses the source database on the storage device 116 and the destination database on the storage device 118 to extract their respective schemas. The executable application 104 also conditions the display generator 109, i.e. the display processor 108 and the display device 110, to display a graphical user interface (GUI) image on the display screen 111 of the display device 110. The user operates the input devices, i.e. keyboard 112 and/or the mouse 114, to interact with the GUI image to control the operation of the transformation system executable application.

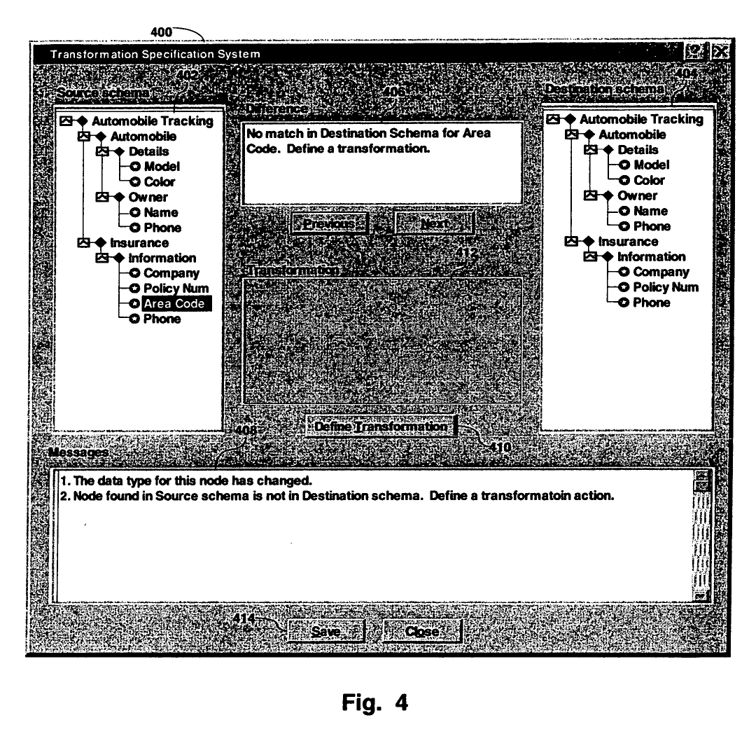

FIG. 4 illustrates an image 400 of a portion of the GUI displayed by the display generator 109 (FIG. 1). The GUI 400 includes a first window 402 showing the data structure of the data elements in the source database (similar to FIG. 2), and a second window 404 showing the data structure of the data elements in the destination database (similar to FIG. 3). The processor 100 automatically compares the structure of the source database to that of the destination database, in a manner described in more detail below.

The structural differences are indicated visually in the first and second windows 402 and 404 of the GUI 400. In FIG. 4, the nodes displayed in the first and second windows 402 and 404 have respective diamond shaped markers displayed to the left of the name attribute of the node. These markers provide the visual indication of structural differences between the schemas of the databases illustrated in the first and second windows 402 and 404. In FIG. 4, the shading of the visual indicator provides the visual indication of structural differences. If this diamond is light gray, this indicates that this node and its progeny are the same in both the source and the destination databases. If this diamond is dark gray, this indicates that there is some difference between this node and its progeny in the source database and the destination database.

This difference may be visually indicated in other ways. For example, the color of the indicator provide the visual indication, e.g. green indicates no difference and red indicates a difference; or nodes which are different between the source and destination databases may be highlighted; or differing nodes may be indicated by differing type styles, such as bold or italic, or a different type face; or markers representing differing nodes may be one symbol or text (e.g. an “X”) and those representing non-differing nodes may be a different symbol or text (e.g. “→”). Any combination of the above techniques, or any other way of visually indicating structural differences in the schemas illustrated in the first and second windows 402 and 404 may be used. Further, structural differences may be visually indicated in one of the first and second windows 402 and 404. In this case, the window in which structural differences are visually indicated may be selected by the user.

A further window 406 in the GUI 400 visually provides more information about the structural differences between the source database and the destination database. A window 408 shows more detailed messages which may assist the user in determining what the difference is and how to properly transform the data element from the source database to the destination database. In FIG. 4, the ‘Area Code’ node of the source schema illustrated in window 402 is highlighted. The “Difference” window 406 displays a more detailed description of the difference related to the ‘Area Code’ node (i.e. that there is no matching node in the destination database schema) and provides guidance to the user in the form of a suggested action to take to resolve the difference (i.e. define a transformation).

The GUI 400 illustrated in FIG. 4 also includes a display element, e.g. a button 410, which enables the user to specify an operation for transforming one or more source data elements into one or more destination data elements in a manner described in more detail below. When a user wishes to define a transformation, the button 410 is activated. The user then defines the transformation in a manner described in more detail below. Once an operation is specified by a user a description of that transformation is displayed in a transformation window 412. One skilled in the art understands that the button 410 may be selectively enabled. More specifically, when a node in the source database is highlighted in the window 402 which is different from a corresponding node in the destination database, then the button 410 may be enabled, otherwise it remains disabled, i.e. grayed out, if a node is highlighted which

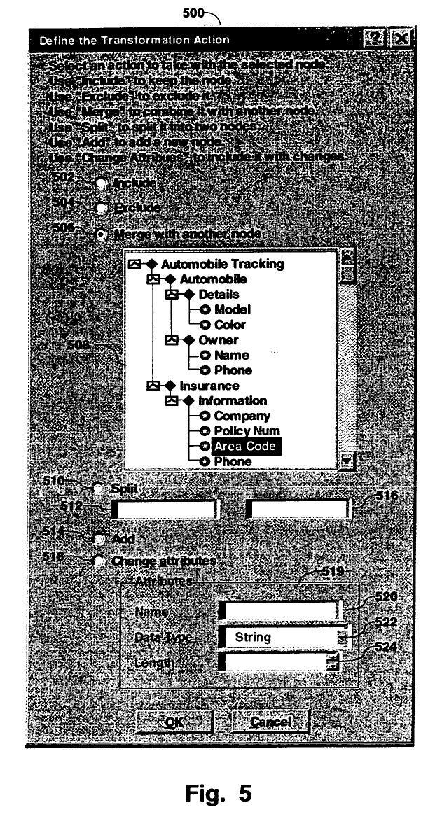

FIG. 5 is an image 500 of an example of another portion of the GUI for specifying an operation for transforming one or more data elements in the source database to a corresponding one or more data elements in the destination database. The image 500 provides a user an easy way to select from among a set of predetermined transformations. As described above, the image 500 is an example of such a GUI and one skilled in the art understands that other transformations may be permitted and that the image 500 may provide a user the option to select such other transformations. Other images (not shown) of additional portions of the GUI may also be displayed in order to provide the user specify such other transformations.

In FIG. 5, a series of radio buttons provides the user a selection of transformation operations. When radio button 502 is activated, the highlighted data element in the source database is included in the destination database. When radio button 504 is activated, the highlighted data from the source database is deleted, and thus excluded from the destination database. When radio button 506 is activated the structure of the source database is displayed in a window 508 (similar to window 402 in FIG. 4). The user may select two or more source database data elements to be merged into a single data element in the destination database. When radio button 510 is activated the structure of the source database is displayed in the window 508. The user may select a source database data element. This data element may then be split into two data elements illustrated in text boxes 512 and 516. These data elements may be assigned to respective data elements in the destination database. When radio button 514 is activated, a new data element is added to the destination database. An attribute designation box 519 is activated to allow the user to specify attributes, and thus the format, of the newly added data elements. Several text boxes within the attribute designation box 519 provide a user to specify attributes: e.g. name 520, data type 522, length 524. One skilled in the art understands that the attribute designation box 519 may contain data fields to specify other attributes. When a radio button 518 is activated, the attributes of a data element in the source database, as selected in the window 508, may be changed using the attribute designation box 519.

As described above, other transformation operations may be specified in a image 500 or other GUI images as required. For example, a data element in the source database may be split into more than two portions; or the hierarchical location of a data element may be changed, i.e. a child data element may be promoted to the level of its parent or grandparent data element, or a parent data element may be demoted to the level of its children or grandchildren data element; or an executable procedure may be developed and specified which may perform more complicated operations on the one or more data elements from the source database to produce the one or more data elements in the destination database.

Referring again to FIG. 4, when a user has specified a desired operation, a description of that operation is displayed in the transformation window 412. As these operations are specified, they are stored in the data transformation specification, as described above. When the required transformations have been specified, the user activates the “Save” button 414. In response, the data transformation specification is saved. Also as described above, a data transformation engine (not described in detail herein) transforms the data from the source database to the destination database in response to the data transformation specification.

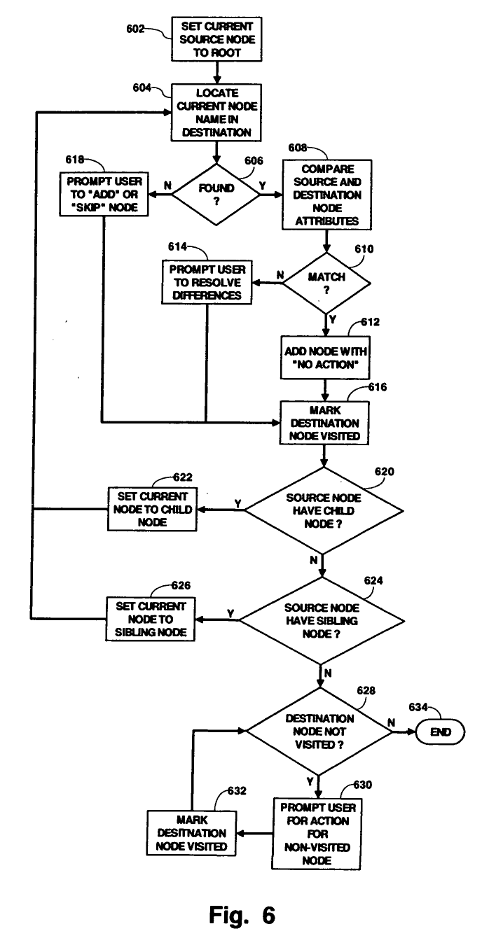

As described above with reference to FIG. 4, the processor 100 (of FIG. 1) executes an executable procedure which automatically determines the differences between the structure of the source database and the destination database. FIG. 6 is a flow chart illustrating the operation of such an executable procedure. The operation of the executable procedure represented by FIG. 6 may be better understood by reference to the source and destination database structures illustrated in FIG. 2 and FIG. 3.

In step 602 of FIG. 6, a current node is set to the root node 200 of the source database. In step 604 the structure of the destination database is evaluated to determine if a node with the name attribute of the current node (source database) exists in the destination database. In step 606, if such a node is found, then the respective attributes of the nodes in the source and destination databases are compared in step 608. In step 610, if the attributes match, this indicates that the node in the source database matches a corresponding node in the destination database. In this case, in step 612 data is added to the data transformation specification to indicate that the nodes match and that no action is to be taken. In addition, the visual matching indicator for those nodes in the windows 402 and 404 (FIG. 4) are set to indicate a match.

In step 610 if the attributes do not match, then in step 614 a message is displayed in differences window 406 indicating that the nodes do not have the same attributes, and inviting the user to resolve the different attributes using the GUI image 500 (FIG. 5). In addition, in the windows 402 and 404 (FIG. 4) the visual matching indicator for those nodes, and their higher nodes in the hierarchy, are set to indicate no-match. In step 606, if a node with a matching name attribute is not found, then an appropriate message is displayed in the differences window 406 indicating that there is no node in the destination database matching the current node and inviting the user to either add this node to the destination database or skip the current node. In addition, in the windows 402 and 404, the visual matching indicator for those nodes, and their higher nodes in the hierarchy, are set to indicate no-match.

In the process illustrated in FIG. 6, the name and attributes of the nodes are compared. One skilled in the art will understand that other aspects of the respective structures of the source and destination database may also be compared. For example, the position of the current data element in the respective source and destination data structures may be compared, e.g. the hierarchical structure of the children of the current node, and/or the hierarchical structure of the ancestors (parents, grandparents, etc.) of the current node.

When the user, in response to the invitations, specifies an operation to perform a transformation, as described above with respect to FIG. 4 and FIG. 5, data is added to the data transformation specification to describe the specified transformation operation. When evaluation of data elements is complete, in step 616, the matching nodes in the destination database structure are marked ‘visited’.

In step 620, the source database structure is evaluated to determine if the current node has a child node. If so, then in step 622 the current node is set to the first child node and the process is repeated from step 602. If not, then in step 624, the source database structure is evaluated to determine if the current node has a sibling node. If so, then in step 626 the current node is set to the next sibling node and the process is repeated from step 602. If not, this indicates that the nodes in the structure of the source database have been evaluated. In step 628, the structure of the destination database is evaluated to determine if nodes have not been ‘visited’ by the steps 604-628, described above. If so, then in step 630 a message is displayed in differences window 406 (FIG. 4) indicating that the node in the destination database is not matched by a corresponding node in the source database, and inviting the user to provide an action for the ‘un-visited’ node using the GUI image 500 (FIG. 5). In addition, in the window 404 the visual matching indicator for that node, and the higher nodes in the hierarchy of the destination database, are set to indicate no-match. When a user specifies a matching operation, data representing the specified transformation operation is stored in the data transformation specification. In step 632 that node is marked ‘visited’ and the next ‘un-visited’ node is located in step 628. If no such nodes are found in step 628, then the executable procedure ends in step 634.

As described above, when the data transformation specification is complete, the data transformation engine may process the source database to transform the data it contains to the destination database.

Although the illustrated embodiment is described with respect to a hierarchical database, one skilled in the art recognizes that any source of data having a data structure, such as relational databases, may be processed in the same manner to provide data transformation from one database to another. One skilled in the art further understands that a hierarchical database may be implemented by a relational database system. For example, the hierarchically ordered data structure, including, parent, child grandchild, etc. data elements, may be comprised in: (a) a data table, a data row within a table and data fields within a row respectively; (b) a data table, a data column within a table and data fields within a column respectively; (c) a data record, a data row within a record and data fields within a row respectively; and/or (d) a data record, a data column within a record and data fields within a column respectively. The data transformation system illustrated in the figure and described above may specify the transformation for databases in any such database system.

1. A data transformation system, comprising:
a display generator for displaying at least one image including:
a first window showing a first data structure having one or more data elements;
a second window showing a second data structure having one or more data elements; and
a display element enabling a user to specify an operation for transforming the one or more data elements in the first data structure to a corresponding one or more data element in the second data structure; and
a processor for comparing said first data structure and said second data structure and for conditioning the display generator to visually indicate structural differences in at least one of, (a) said data structure shown in said first window and (b) said data structure shown in said second window.

2. A system according to claim 1, wherein said user is able to select an operation from at least one of, (a) merging data elements, (b) splitting a data element into multiple data elements and (c) adding a data element.

3. A system according to claim 1, wherein said user is able to select an operation from at least one of, (a) deleting a data element and (b) changing format of data conveyed in a data element.

4. A system according to claim 1, wherein said structural differences are visually indicated by at least one of, (a) highlighting, (b) bolding, (c) coloring, (d) shading and (e) symbols or text.

5. A user interface system enabling data structure alteration, comprising a display menu generator for initiating display of at least one image including:
a first window showing an existing hierarchically ordered data structure including, a parent data element associated with a child data element, said child data element being associated with a grandchild data element;
a second window showing a proposed different hierarchically ordered data structure including one or more transformed data elements corresponding to said parent, child and grandchild data elements following a data structure transformation; and
display elements enabling a user to select an operation for transforming at least one of said parent, child and grandchild data elements to said corresponding one or more transformed data elements.

6. A system according to claim 5, wherein said user is able to select an operation from at least one of, (a) merging data elements, (b) splitting a data element into multiple data elements and (c) adding a data element.

7. A system according to claim 5, wherein said user is able to select an operation from at least one of, (a) deleting a data element and (b) changing format of data conveyed in a data element.

8. A system according to claim 5, including a data processor for comparing said existing hierarchically ordered data structure and said proposed different hierarchically ordered data structure and for visually indicating identified structural differences in at least one of, (a) said data structure shown in said first window and (b) said data structure shown in said second window.

9. A system according to claim 8, wherein said structural differences are visually indicated by at least one of, (a) highlighting, (b) bolding, (c) coloring, (d) shading and (e) symbols or text.

10. A system according to claim 8, wherein said data processor compares said existing hierarchically ordered data structure and said proposed different hierarchically ordered data structure by comparing two or more of, (a) names of data elements, (b) position of data elements in respective existing and proposed data structures and (c) type of data in data elements of in respective existing and proposed data structures.

11. A system according to claim 5, wherein said proposed hierarchically ordered data structure includes, parent, child and grandchild data elements comprising a data table, a data row within a table and data fields within a row respectively.

12. A system according to claim 5, wherein said proposed hierarchically ordered data structure includes, parent, child and grandchild data elements comprising a data table, a data column within a table and data fields within a column respectively.

13. A system according to claim 5, wherein said proposed hierarchically ordered data structure includes, parent, child and grandchild data elements comprising a data record, a data row within a record and data fields within a row respectively.

14. A system according to claim 5, wherein said proposed hierarchically ordered data structure includes, parent, child and grandchild data elements comprising a data record, a data column within a record and data fields within a column respectively.

15. A user interface system enabling data structure alteration, comprising:
a display menu generator for initiating display of at least one image including:
a first window showing an existing hierarchically ordered data structure including, a parent data element associated with a child data element, said child data element being associated with a grandchild data element,
a second window showing a proposed different hierarchically ordered data structure including one or more transformed data elements corresponding to said parent, child and grandchild data elements following a data structure transformation, and
display elements enabling a user to select an operation for transforming at least one of said parent, child and grandchild data elements to said corresponding one or more transformed data elements; and
a data processor for comparing said existing hierarchically ordered data structure and said proposed different hierarchically ordered data structure and identifying differences.

16. A system according to claim 15, wherein said data processor identifies differences in data type and data structure and visually indicates differences in corresponding data elements in at least one of, (a) said data structure shown in said first window and (b) said data structure shown in said second window.

17. A system according to claim 15, wherein said display elements enabling a user to select an operation for transforming at least one of said parent, child and grandchild data elements to said corresponding one or more transformed data elements, are displayed in response to said identified differences.

18. A system according to claim 17, including a transformation data generator for generating transformation data determining transformations to be performed to convert said existing hierarchically ordered data structure to said proposed different hierarchically ordered data structure, in response to said user selected operation.

19. A system according to claim 18, including a transformation processor converting said existing hierarchically ordered data structure to said proposed different hierarchically ordered data structure using in response to said transformation data.

20. A system enabling data structure alteration, comprising:
an interface processor for receiving:
data representing an existing hierarchically ordered data structure including, a parent data element associated with a child data element, said child data element being associated with a grandchild data element,
data representing a proposed different hierarchically ordered data structure including one or more transformed data elements corresponding to said parent, child and grandchild data elements following a data structure transformation,
data representing a user selected operation for transforming at least one of said parent, child and grandchild data elements to said corresponding one or more transformed data elements; and
a data processor for comparing said existing hierarchically ordered data structure and said proposed different hierarchically ordered data structure and identifying differences.

21. A method for providing a user interface enabling data structure alteration, comprising the activities of:
initiating display of at least one image including:
a first window showing an existing hierarchically ordered data structure including, a parent data element associated with a child data element, said child data element being associated with a grandchild data element,
a second window showing a proposed different hierarchically ordered data structure including one or more transformed data elements corresponding to said parent, child and grandchild data elements following a data structure transformation, and
display elements enabling a user to select an operation for transforming at least one of said parent, child and grandchild data elements to said corresponding one or more transformed data elements.
